(19) United States
(12) Patent Application Publication
(10) Pub. No.: US 2016/0323722 A1
(43) Pub. Date: Nov. 3, 2016

(54) Method and System for Improving the Safety of Driving While Communicating

(71) Applicants: Katherine Rose Kovarik, Englewood, CO (US); Joseph E. Kovarik, Englewood, CO (US)

(72) Inventors: Katherine Rose Kovarik, Englewood, CO (US); Joseph E. Kovarik, Englewood, CO (US)

(21) Appl. No.: 15/155,278

(22) Filed: May 16, 2016

Related U.S. Application Data
(63) Continuation-in-part of application No. 14/938,352, filed on Nov. 11, 2015.
(60) Provisional application No. 62/163,163, filed on May 18, 2015.
(60) Provisional application No. 62/163,163, filed on May 18, 2015.
(60) Provisional application No. 62/078,539, filed on Nov. 12, 2014.

(51) Int. Cl. H04W 4/12; H04M 1/725; B60R 1/00; B62D 1/04; B62D 15/00

(52) U.S. Cl. CPC H04W 4/12; B62D 1/04; B62D 15/00; B60R 1/00; H04M 1/72552; B60R 2300/205

(57) ABSTRACT

A method and system for improving the safety of drivers of vehicles while either sending or receiving written communications to third parties includes a steering wheel mounted keyboard such that the opposing thumbs of a driver can send and revive text messages, e-mails, etc., with the display of such text messages being projected via a HUD display onto the windshield of the vehicle. The driver's hands are thus always on the steering wheel in approximately the preferred 10 o'clock and 2 o'clock positions and the driver's view is directly on the road through the windshield directly in front of the driver while any text message is being composed, thus reducing the many accidents that occur due to drivers being distracted when viewing their Smartphone messages and taking their eyes off the road while doing so. Avoidance of gesture based controls or oral/voice controls is also preferred as such gestures require a driver's hands to leave the steering wheel and thus jeopardize the safety of the driver.

### RELATED APPLICATIONS

This application claims priority from U.S. Provisional Patent Application No. 62/163,163, filed May 18, 2015. This application also claims priority from U.S. patent application Ser. No. 14/938,352, filed Nov. 11, 2015, which claims priority from U.S. Provisional Patent Application No. 62/163,163, filed on May 18, 2015 and U.S. Provisional Patent Application No. 62/078,539, filed on Nov. 12, 2014. The entire disclosure of the prior applications are considered to be part of the disclosure of the accompanying application and are hereby incorporated by reference.

### FIELD OF THE INVENTION

The present invention is generally directed to a method and system for improving the safety of drivers of vehicles while either sending or receiving written communications to third parties.

### BACKGROUND OF THE INVENTION

Texting while driving is an act that is universally condemned as being antithetical to safe driving. And yet it is conduct that nearly every driver has at one point engaged in. The logic of why it is a bad habit is undeniable—with eyes taken off the road in a belief that it will be just for a second—is a lie every texting driver tells themselves. The fact that death or injury does not occur each time this happens merely means that texting while driving survives and continues as a bad habit, denied by most and regretted by all. To address this most unfortunate of bad habits, there are a growing number of patented inventions directed to technologies that preclude one from texting while driving. The adoption of such technologies depends upon the voluntary admission of drivers that they simply cannot control themselves when it comes to the addiction of texting while driving. The threat of legal action is not enough to stop it. And having the diving populace collectively agree to employ technologies that deprive them of a technology so central to their daily lives seems like a plan destined to fail. Even if a great number of the public adopt such “texting and driving” preclusive technologies, that still leaves a large number of the driving public that will still be texting while driving, exposing everyone to its detrimental effects. There must be a better way. Various embodiments of the present invention provide an alternative to this long felt but unsolved problem.

Texting while driving is a growing trend, and a national epidemic, quickly becoming one of the country's top killers. Drivers assume they can handle texting while driving and remain safe, but the numbers don't lie. There are almost two million accidents a year in the US due to texting while driving, resulting in over 300,000 injuries each year and 11 deaths of a teen every day. Nearly 25% of ALL car accidents is attributable to texting while driving. In comparison, texting is about 6 times more likely to cause an accident than driving intoxicated and equivalent to driving after 4 beers. Studies show that drivers using mobile phones are four times as likely to cause an accident. Furthermore, someone talking on a phone is as likely to be involved in an accident as someone with a 0.08 blood alcohol content level.

The National Hwy Transportation Safety Administration reports indicate that it is the number one driving distraction reported by teen drivers; makes one twenty-three times more likely to crash; is the same as driving blind for 5 seconds at a time; slows one's brake reaction speed by 18%; and leads to a 400% increase with eyes off the road. It is presently believed that drivers exhibit nearly identical impairment in the reading and writing conditions, suggesting that both reading and writing text-based messages may be equally dangerous.

While legislation has been passed in reaction to the above dangers of texting, it is a difficult enforcement problem. The urge for drivers to ‘multi-task’ because of work pressures or running late override concerns for their own safety and that such conduct is against the law seems not to seriously deter many drivers on the road. Thus, others have attempted to address the issue by implementing systems that block cell phone signals inside the car. But few individuals actually want to deprive themselves of the use of a cell phone/Smartphone in a car as they spend so much time there and feel, rightly or wrongly, that they need to be in near constant contact with others, especially in the case of an unexpected emergency. Others suggest that ‘no texting while driving’ education and public service messages need to be continued and expanded to target both teen and older drivers. The “just don't do it” slogan seems not to have worked for texting and driving, and human behavior is much harder to change than technology. Thus, to address the long-felt problem of distracted driving as a significant contributor to motor vehicle accidents and fatalities, and appreciating that texting is and promises to continue to be a particularly significant form of driver distraction in the future, there is a need for a simple system and method that can be readily employed inside of vehicles' such that the driver distraction caused by texting is at least reduced. The present embodiments of the invention as described herein accomplish this objective.

The central place of automobiles, driving, and car culture in many contemporary societies has meant that people spend a great deal of time in cars. It was not until 2008-2009 that manufacturers offered “genuine’ Internet access in cars. BMW's iDrive system included accessing the Internet directly on the iDrive system and TV screens and provided wireless Internet functionality in the car for drivers and passengers to access via an Internet-equipped mobile. Now the Smartphone has emerged as a cardinal technology for the future of the Internet.

Exchanging text messages in public, and consequently texting while driving, has become normalized, and people are now socialized into such behaviors through observing others texting while driving and using a mobile while driving. Ultimately, texting while driving has become a cultural artifact in the United States, which conflicts with driver safety as well as laws prohibiting texting while driving. There exists a long-felt but unsolved need for a method and a system that provides a safer way for drivers of vehicles to communicate with third parties while driving.

### SUMMARY OF THE INVENTION

One aspect of the present invention relates to providing a heads-up display (and in some embodiments a read aloud function) that does not obstruct a user's view of the surrounding environment, but still presents information, such as texts, pictures, etc. that would otherwise be displayed on a person's Smartphone, on the windshield in front of the driver. Driving is a visual endeavor and keeping the driver's eyes focused on the road is the best way to address the problem of driver inattention.

Moreover, the system includes devices retrofittable with existing vehicles which does not require the driver to remove his hands from a controlling grip on the steering wheel. Thus, the driver maintains eye contact with the road at all times and is not fiddling with controls of a handheld phone while attempting to read text on such smaller screens, held away from the visual point of reference for a driver. In certain embodiments, texting-and-driving is facilitated but in a much safer format such that accidents and injuries and death are lessened. The task of texting is conducted in a manner such that does not provide information that alters the intent of the driving task, reducing confounding factors in analysis of the device's impact on driving performance. The results of this study suggest that Glass performs much closer to baseline than the other technologies. Evidence from this preliminary investigation was used to form a complete study evaluating texting-and-driving with Google Glass. Results from these studies can be used to inform developers of wearable technologies and policymakers tasked with regulating the use of these technologies while driving.

The driver is mainly guided by vision for driving, and visual information can be lost in the quantity of information displayed to the driver and this can have a negative effect on driving safely since the visual faculties competes with the same perceptual and cognitive resources as the task of driving.

Display arrangements have been proposed which display information on a predetermined section of a windshield in front of the driver that display vehicle information to the driver such as speed fuel, time, and other indicators for vehicle driving. A larger, head up display that displays text onto a driver's windshield in a manner such that the driver can easily read such text while maintaining their vision on the road is one aspect of many embodiments of the present invention.

Another aspect relates to reversibly detachable keyboards for data entry while a driver is driving without the driver having to let go of the steering wheel. Various ways can be employed to attach such keyboards, but in certain preferred embodiments, the keyboard is fashioned such that there are two distinct areas with letters (and numbers) such that a driver can readily type in text by use of their opposing thumbs while their hands are wrapped around the steering wheel, preferably at about the 10 o'clock and 2 o'clock positions on the steering wheel. Attachment means can include, but are not limited to use of hook-and-loop structures (Velcro™) such that a simple adherence of the keyboard (or keyboard components, such as two distinct left and right keyboard components, each having distinct letters/numbers associated with either the left or the right portions) can be secured to the steering wheel to facilitate thumb driven texting of messages while the driver has the steering wheel at approximately a straight-up orientation. Thus, the texting of messages while one is turning the steering wheel would be difficult and certainly not preferred. But when the driver has the vehicle steered straight ahead so that the driver's hands are at the preferred 10 AM and 2PM positions on the steering wheel, they can text relatively easily without having to turn the wheel. The text would appear on the windshield in front of them, preferably just below the direct straight-ahead line-of-sight, and just above the dashboard, but otherwise within the normal field of vision of a driver that is gazing out of the windshield to the exterior environment of the vehicle. the clip-on split key boards so that a driver can readily mount such keyboard elements to a steering wheel such that the driver can largely employ their thumbs to press text keys in order to type while driving, with the text being displayed in real time on the windshield in front of the driver. By having the driver's attention always focused on the front of the vehicle and out the windshield, the driver avoids taking their eyes off the road to view a console or to view a handheld Smartphone, etc. In various preferred embodiments, there is provided a mounting unit for a driver's Smartphone such that once in the holster, the phone then interacts with the vehicle display system such that the images on the phone are conveyed to the windshield display so that the driver views an enlarged image of what is on the Smartphone. Similarly, the driver's working of the split keyboard with their thumbs acts to generate text that is displayed on the windshield in front of the driver, but is also conveyed to the Smartphone while it is retained in the holster, thus facilitating the ability to send and receive messages while the driver is driving. Alternatively, Bluetooth and other remote sensing technologies can be employed to provide communication between the head up display of the vehicle with a Smartphone so as to give the driver the choice of texting while driving without the typical dangers associated with such activities, and alleviating the hazards associated with the driver having to divert attention away from the windshield view of the vehicle while attempting to text or to otherwise read messages on his handheld phone or Smartphone.

In various embodiments the Smartphone of a driver is reversibly attachable to a windshield display system either remotely via a Bluetooth communication or in other embodiments via a hard wired system such that the Smartphone is held in a holster coupling and has signals communicated to the display system via one or more wires or via wireless communications. Preferably, the display for the windshield is accomplished without any view obstructive hardware components being particularly visible by the driver when reading texts on the windshield. The projection of text messages to the interior of the windshield can be accomplished in various ways that will be known to those of skill in the art. As described in various references incorporated herein by reference, technologies that have previously been employed to present, for example, the speed of the vehicles onto the windshield, can be employed—but in a larger format to accommodate easy reading of textual messages displayed on the windshield. For example, in certain embodiments, a strip of achieve material that is transparent to a large extent but that has the characteristic that it can reflect in such a way that text projected onto the material reflects back to the eye of the driver such that the text can be read. Alternative methods and devices can be employed to place a suitable “screen” for the display of textual messages on the windshield in front of a driver, including those can be reversibly secured in position for particular drivers, and removed so as not to burden yet another driver of the vehicle with such a display screen. In still other embodiments, different screen configurations can be employed to be selected by a driver for particular situations, such as different light conditions, different visual preferences of the driver, different magnification of text abilities, etc.

The present invention is believed to be superior to various prior art systems in that the head up display is considerably larger than traditional systems that were employed to display speed, etc. rather than full text messages generated and conveyed via a driver's Smartphone. It is believed that information acquired from a display located close to the road view renders the driving performance as being less degraded than for a distant display. Using a Head-Up Display (HUD) can facilitate decreased response times and increased driving comfort. While not bound by theory, it is believed that the detection of signals is easiest near the line of sight, and it decreases significantly for larger eccentricities, especially the vertical. Thus, a HUD can increase the time the eyes are kept on the road. Since it is desirable to keep the eyes on the road, the fewer glances towards the vehicle interior—the better it is for overall vehicle safety.

In certain embodiments, the present system and method may further employ driver gestures, such as a swipe left in the air to answer a call, swipe right to dismiss a notification, as well as provision of voice cues to write texts or tweets, all of which can be displayed on the HUD screen.

To reduce the need to provide extensive disclosure in this application, but to provide adequate written description of the various devices and methods encompassed by the numerous embodiments of the present invention, various patents are incorporated herein in their entireties by this reference. These include: U.S. Pat. No. 7,062,365 to Fei; U.S. Pat. No. 7,493,215 to Katsuaki; U.S. Pat. No. 7,680,574 to Berg; U.S. Pat. No. 7,765,045 to Yoshida; U.S. Pat. No. 7,990,366 to Louge; U.S. Pat. No. 8,301,108 to Naboulsi; U.S. Pat. No. 8,494,723 and 2011/0196578 to Strohmaier; 2010/0127996 to Kitahara; U.S. Pat. No. 9,030,424 to Shih et al., U.S. Pat. No. 8,542,196 to Pallakoff; U.S. Pat. No. 8,781,838 to Krause; U.S. Pat. No. 8,164,543 and U.S. Pat. No. 8,606,430 to Seder; 2012/0262673 to Larsson; 2014/0292665 to Lathrop; 2014/0113619 to Tibbitts et al.; 2013/0281079 to Vidal; 2012/0028682 to Danne; 2014/0062891 to Powell; 2016/0025973 to Guttag; 2016/0090055 to Breed; 2015/0149035 to Enthaler et al.; 2015/0148019 to Michaelis; 2015/0168175 to Abramson et al.; 2015/0148019 to Michaelis; 2014/0058584; 2014/0281957 to Weng et al.; 2015/0286952 to El Dokor et al.; and 2015/0269936 to Alameh et al.

Data that is critical to driver decision making is presently typically displayed in multiple locations—on a centre console or instrument panel, etc., making it difficult for the driver to assimilate such data quickly and safely. It is believed that drivers and the public would benefit greatly from a visual interface that focuses a driver's attention on the road ahead. The head-up display (HUD) has been around since General Motors first installed one way back in 1988. Today, information available on the instrument cluster—such as speed, fuel, temperature, indicators and warning lights—may all appear on a heads-up system.

In preferred embodiments, a vehicle is fitted with an HUD that provides images directly in front of the driver's eyes. Systems, such as one proposed by a startup called Navdy, employ a heads-up display where a tiny projector beams turn-by-turn directions, Twitter notifications and other social-media notes onto a screen above the steering wheel. While variations of the Navdy system can be used in various versions of the present invention, preferably a driver does not employ hand gestures to address content presented on a front-facing screen, but rather, the driver should preferably have both of his/her hands on the steering wheel to properly drive the vehicle. Thus, one important distinction with respect to certain preferred embodiments of the present invention as contrasted with the prior art is that a thumb-operated input system is preferably mounted on the driver's steering wheel in a fashion such that text messages can be typed when the driver's hands are properly in contact with the steering wheel—and the driver is focused on the windshield ahead. In such a fashion, the direr retains the all important visual attention on the road, rather than diverting attention to consoles or other features that may communicate information to the driver while he/she is driving. Moreover, the driver always has his/her hands properly positioned on the steering wheel for what has been deemed to be the preferred positioning of a human's hands on a steering wheel so as to best address any road conditions: 10 ‘o'clock and 2 o'clock hand positions on the steering wheel. The provision of a text keyboard that is associated with a driver's steering wheel in just this preferred positioning ensures that the driver does not take their hands off the wheel to gesture, etc.

It is common place for individuals to perform hand gestures while talking. Such behavior is sometimes unconscious in that a speaker does not really appreciate how their hands and arms are moved when expressing oral communications. Such gestures in a vehicle that are performed by drivers can be a significant impediment—if not a outright danger—if a system, such as the Navdy system, is employed, which reads certain gestures and then generates certain actions (e.g. text messages, changing of screens, etc.) that can excite and distract a driver unnecessarily. Thus, there is a danger that unconscious hand gestures that relate to a person's normal habit of expressing themselves while speaking to another while in a vehicle, (especially if it is a new autonomous driving vehicle or one that employs a Navdy—type system) could result in unintended consequences, which could direct the vehicle to perform in a way that the driver did not intend. It may also be that such gestures could make the texting of a message to another something other than what the driver (as the sender of a message) was not prepared to send. It is a common experience for one to regret sending an e-mail or tweet inadvertently and before properly reviewing the text/tweet before hitting send. But the added frustration and tension caused by the sending of a text or e-mail or tweet due to the system employed in the vehicle that is reading hand/arm gestures—and the consequent distraction of the driver—could make the intended act of driving more dangerous—rather than less dangerous. Indeed, there are several published patent applications of Google that are directed to hand gesture reading systems that could pose just such a type of dilemma for a driver. E.g. see U.S. Pat. Publication No. 2014/0121883 to Shen et al., also incorporated herein by this reference.

In various embodiments of the invention, the system is designed and adapted so that if a driver does not have both his/her hands on the steering wheel, the texting function of the system is disabled. This ensures that a driver does not become distracted while attempting to both drive and to text at the same time. The disabling ability of the texting function can be accomplished in various ways, including stopping the HUD display of the text; by canceling the texting function by rendering the keyboards inactive unless both hands are on the steering wheel at the same time, etc. and in preferred embodiments is accompanied by sounding an alarm, preferably a sound or a vibration of the steering wheel, etc. to inform the driver that both hands must remain on the steering wheel for the “texting while driving” functionality to operate. As one will appreciate, reference herein to texting is intended to encompass other similar functions, such as the receipt and sending of e-mails, tweets, and other similar types of communications. One of skill in the art will also appreciate and understand the various different ways to implement a cessation of texting abilities (whether it be the ability for a driver to receive texts or create and/or send texts) during the driving of the vehicle. Thus, unlike other systems that enable a driver to become distracted by permitting voice commands and gesturing to affect screen displays on an HUD, the present system is focused and directed to the safety of the driver (and the other passengers in the vehicle) in precluding the generation, receipt or sending of texts when the driver fails to maintain both hands at the preferred 10-2 o'clock positions on the steering wheel.

The foregoing has outlined rather broadly various pertinent and important features of various embodiments of the present invention in order that the detailed description of the invention that follows may be better understood. Such description is, however, not to be considered as limiting the invention in any way. In this respect, before explaining at least one embodiment of the device and method herein in some detail it is to be understood that the invention is not limited in its application to the details of construction and to the arrangement of the components set forth in the following description or illustrated in the drawings. The invention is capable of other embodiments and of being practiced and carried out in various ways which will become obvious to those skilled in the art who read this specification. Also, it is to be understood that the phraseology and terminology employed herein are for the purpose of description and should not be regarded as limiting of the invention in any fashion. As such, those skilled in the art will appreciate that the conception upon which this disclosure is based may readily be utilized as a basis for designing of other structures, methods and systems for carrying out the several purposes of the present invention. It is important, therefore, that the claims be regarded as including any such equivalent construction insofar as they do not depart from the spirit and scope of the present invention.

### BRIEF DESCRIPTIONS OF THE FIGURES

FIG. 1 is a depiction of a steering wheel with associated left and right keyboards that are affixed to the steering wheel so that a driver's thumbs can operate the keypads while maintaining the driver's hands on the steering wheel at 10 o'clock and 2 o'clock positions on the steering wheel.

FIG. 2 is a view of a vehicle's interior from a driver's perspective with the split keyboards mounted on the steering wheel.

FIG. 3 is a perspective view of a driver in a vehicle that is provided with a HUD display and the mounted split keyboard associated with the steering wheel of the vehicle.

FIG. 4 is another view of a vehicle having a mounted split keyboard on the steering wheel, with an HUD display positioned on the dashboard in front of the driver.

### DESCRIPTIONS OF CERTAIN PREFERRED EMBODIMENTS

Various embodiments of the present invention provide a head-up-display device for a vehicle that permits a driver to view and respond to information communicated to a driver's Smartphone, cell phone, laptop, tablet computer, etc., without taking the driver's eyes off the road when the vehicle is moving.

In certain embodiments, included features of such a system include a navigation, speed display, music control, but primarily text message display and response.

An HUD system is associated with steering wheel 20 mounted keyboard 10, 12 portions so that an image is projected onto a transparent lens that magnifies the image and makes it appear to float outside the car's windshield. The image of text messages or e-mail messages is focused into the virtual distance on the windshield interior so that the driver never has to look away from the road. Preferably, the system is controlled via a steering wheel mounted keyboard 10, 12 that is operated by a driver's opposed thumbs, rather than being solely operated via touchless gesture controls or via a voice recognition system, such as Siri and Google Now. Preferably, notifications appear directly in front of the driver, more preferably on the lower portion of a driver's view through the windshield, but can also be adjusted so that the image of messages can be displayed at other particular areas, as long as the driver's view of the road while driving is not obscured, thus providing a driver with the ability get real-time notifications from the driver's Smartphone.

In various embodiments, an appropriate app is download to the driver's Smartphone device (e.g. Android or IOS device) and such app directs a driver through the software downloading process so as to install the system. The system is then connected to the vehicle's OBD II port or the 12V power outlet and the HUD display as well as the steering wheel 20 mounted keyboard 10, 12 are attached to the vehicle, e.g. via Velcro attachments, adhesive attachments, physical snap-on systems, sliding-type mounts that rely upon tongue and groove interaction between components, etc. The system in various embodiments is powered by the vehicle's on-board diagnostics (OBD II) port and further relies on the same to communicate with the vehicle. While the OBD II port can output information like a vehicle's speed, RPM, mileage, fuel, check engine status, and other internal statistics in real time, the main feature is the ability to safely text messages while driving and while having the driver's attention not misdirected away from the view of the road and without having the driver's hands off the steering wheel in order to perform hand gestures to operate the system or hand gestures that a driver may perform as they orally express themselves in oral communications, such gestures often unconsciously performed due to force of habit.

The system preferably connects to a driver's Smartphone via Bluetooth with pairing being straightforward and auto connect functions available for particular driver's of the vehicle being recognized.

The HUD image is preferably focused into the distance so the road stays in focus while the driver views the information presented as projected onto the interior glass surface of the windshield, employing similar technology as used in commercial airplanes so the pilot can keep their eyes on the runway while landing the airplane. In other embodiments, a windshield-embedded screen that facilitates such displays is preferred. The various embodiments of the present invention change the way a driver interacts with their Smartphone while driving. The system can be integrated with a vehicle's system, or can be retrofitted to existing vehicles by mounting of a HUD display projector and having a Smartphone connected via Bluetooth or hard wired to the vehicle (e.g. via mounting in a holster for such a Smartphone), thus providing a high-resolution heads-up display that helps a driver view the road while receiving or creating text messages with their respective two hands on the steering wheel. Thus, the present system and method provides for a way for texting drivers to avoid taking their eyes off the road, which will decrease the chances of an accident by minimizing in-driving distractions.

In various embodiments of the present invention, and in contrast to the Navdy system, instead of a driver's controls being entirely performed with touch-less gestures and voice commands, the driver's hands are on the steering wheel 20 when the text entry or other controls of the present system are performed. Yet similar to certain systems, such as Navdy, a driver can configure settings through the iOS and Android app on a Smartphone. For example, a driver can control music via a music app that supports Bluetooth, such as Pandora, Spotify, iTunes and Google Music, by thumb operated keys on a keyboard 10, 12 reversibly associated with a vehicle's steering wheel 20 such that the driver can control functions such as play, pause, and skip forward/back tracks.

In certain embodiments the driver's Smartphone connects to the vehicle's sound system on its own. But the keyboard 10, 12 operated control system is preferably powered by connecting it to the vehicle's on-board diagnostics (OBD II) port, typically located below the steering wheel 20 just to the left. Alternatively, an accessory for vehicles without OBD II ports can be provided to permit powering the system through a 12V power outlet in a vehicle.

The HUD of the system can be either hardwired into a vehicle or reversibly associated with the vehicle via mounting assemblies that one of skill in the art will appreciate, including but not limited to “friction mounts” to associated the HUD projection system to the vehicle's dashboard. Such HUD system mounts may be adhesively mounted or non-adhesive (so as to avoid damaging the vehicle's dashboard).

In addition to Smartphones, in various embodiments the present system is suited for tablet systems, such as an iPad, Kindle, Notebook computers, laptops, etc. Preferably, the system connects to the internet, e.g. through a smart phone, and thus does not require a separate Internet connection, but in other embodiments, a separate internet connection is provided for the system, thus permitting certain functions and performance characteristics independent of a driver's Smartphone.

Various embodiments of the present invention permit the driver to perform texting while not directly touching the driver's Smartphone, but still interacting with the phone via a steering wheel 20 mounted keyboard, preferably a split keyboard 10, 12 that facilitates thumb operated texting, and thus permits the driver to perform texting and other e-mail communications, etc. in a manner that does not divert visual attention from the road. The ability to send and receive text messages so that such messages appear while the vehicle is moving, rather than merely being stationary, and without having commands and controls via oral communications, nor hand or arm or eye, head or other body “gestures”, is believed to be an especially important factor in saving lives by having the driver's attention and hands physically on the wheel 20 of the vehicle at the critical times when such communications are being performed.

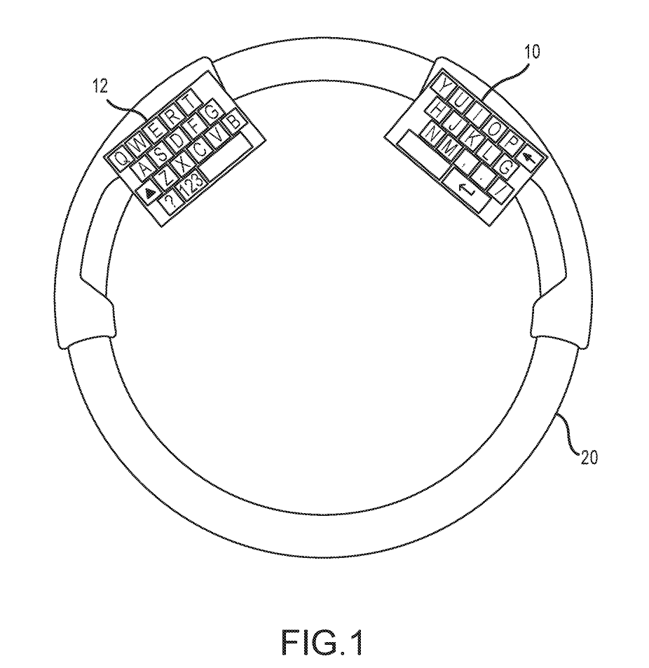

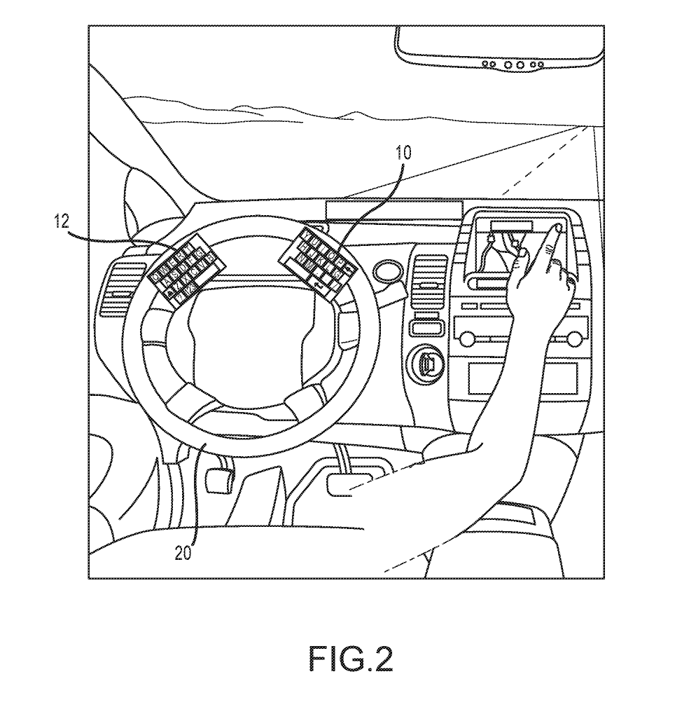

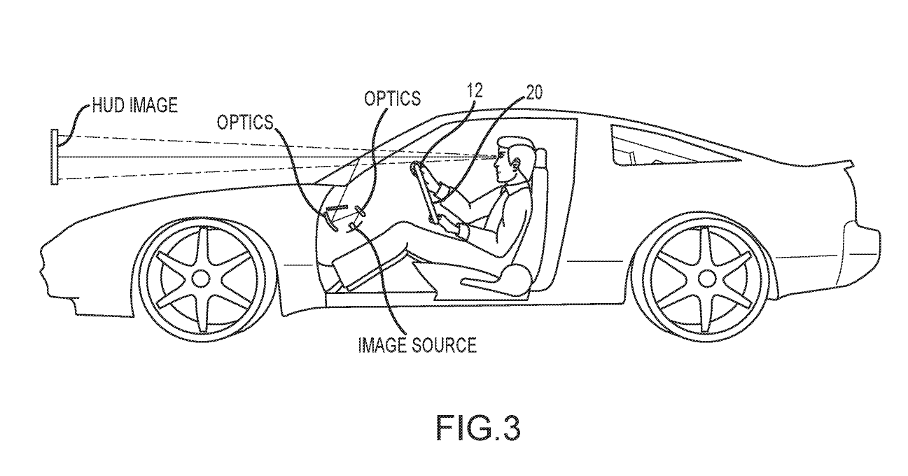

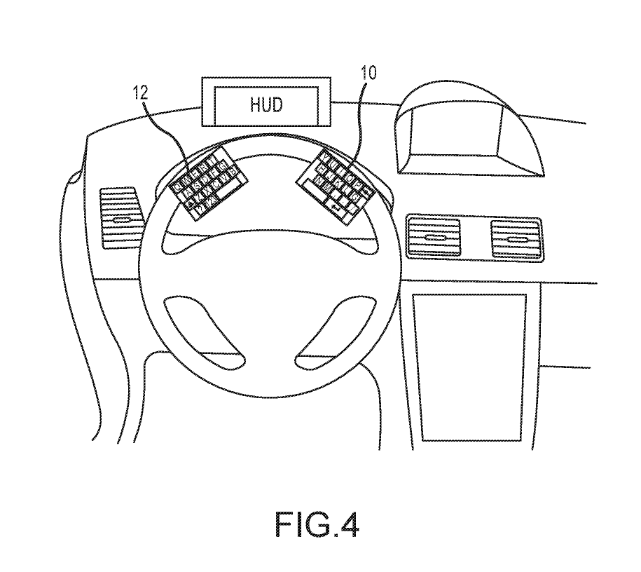

With reference to FIGS. 1-5, in various embodiments a vehicle's steering wheel 20 is associated with left and right keyboards that are affixed to the steering wheel 20 so that a driver's thumbs can operate the keypads while maintaining the driver's hands on the steering wheel 20 at 10 o'clock and 2 o'clock positions on the steering wheel. Thus, in various embodiments a communications device for use with an a vehicle to facilitate safe texting while driving includes structural and functional features, including a HUD projection system adapted for association with a vehicle to project text onto the windshield interior of a vehicle directly in front of a driver of the vehicle. A first hand unit is attached to the steering wheel adjacent the left hand of the user, with such a first hand unit comprising a first alpha-numeric keyboard suitable for texting with the left thumb. A second hand unit is attached to the steering wheel adjacent the right hand of the driver and includes a second alpha-numeric keyboard suitable for texting with the right thumb. The first alpha-numeric keyboard includes some but not all of the letters of the alphabet and the second alpha-numeric keyboard includes at least those letters of the alphabet not on said first alpha-numeric keyboard. The first keyboard and the second keyboard form a complete qwerty keyboard suitable for texting. A hand detecting sensor is associated with the first hand unit and the second hand unit. Such hand detecting sensor is adapted to preclude text communications from being entered and/or displayed on the HUD if either of the first hand unit or said second hand unit is not in contact with both respective hands of the driver while on the steering wheel when the vehicle is in motion. Preferably, a driver's left and right hands are in contact with the steering wheel in approximately 10 o'clock and 2 o'clock positions about the steering wheel, and the sensors detect such contact, thus enabling the texting function to proceed. Such contact sensors can be of any particular shape and size, and can for example, resemble those sensors commonly found on gym exercise equipment (e.g. those that detect when a person has a hold of a hand grip on a stationary bicycle, etc.) U.S. Pat. Nos. 8,841,929 and 9,024,741 to Bennett et al. and Patent Publication No. 2011/0133919 to Evarts are incorporated by this reference in their entireties. Using the present system, a driver is able to input text by using his/her respective thumbs, with the image of such textual messages produced being projected onto the HUD system such that text can be read by the driver while said driver's view is maintained through the front windshield of the vehicle. Preferably, the communications device has associated with it in either or both of the first hand unit and second hand unit, an alert that comprises a vibratory motor, such that when contact is not made by both hands on the steering wheel at the designated positions (e.g. 10-2 o'clock positioning of the driver's hands) then a vibratory signal is made to the driver to warn them of such a fact, just after a failure to recognize both hand contact with the steering wheel. In various embodiments the communications device includes the first hand unit and said second hand unit reversibly associated with a steering wheel of a vehicle. In other forms, such units are integral with the steering wheel. Preferably, no screen feature is associated with the steering wheel, thus forcing or compelling the driver to look straight ahead and out the front of the vehicle's windshield in order to view text either communicated to them or generated by them via the communications device as described herein. Preferably, the screen, first keyboard and second keyboard are all in wireless communication to a cell phone or a Smartphone of the driver while they are present in the vehicle.

Additional features of the invention as found herein form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

What is claimed is:

1. A communications device for use with a vehicle to facilitate safe texting while driving, comprising:
a HUD projection system adapted for association with a vehicle to project text onto the windshield interior of a vehicle directly in front of a driver of the vehicle;
a first hand unit attached to said steering wheel adjacent the left hand of the user, said first hand unit comprising a first alpha-numeric keyboard suitable for texting with the left thumb;
a secondhand unit attached to said steering wheel adjacent the right hand of said user, said second hand unit comprising a second alpha-numeric keyboard suitable for texting with the right thumb wherein said first alpha-numeric keyboard includes some but not all of the letters of the alphabet and said second alpha-numeric keyboard includes at least those letters of the alphabet not on said first alpha-numeric keyboard, wherein said first keyboard and said second keyboard form a complete qwerty keyboard suitable for texting;
a hand detecting sensor associated with the first hand unit and the second hand unit, said hand detecting sensor adapted to preclude text communications from being entered on either of said first hand unit or said second hand unit if a driver's hands are not both contacting a steering wheel to which said communications device is attached;
wherein when a driver's left and right hands are in contact with the steering wheel in approximately 10 o'clock and 2 o'clock positions about the steering wheel, the driver is able to input text by using his/her respective thumbs, with the image of such texts being projected onto the HUD system such that text can be read by the driver while said driver's view is maintained through the front windshield of the vehicle.

2. The communications device of claim 1 wherein one of said first hand unit and second hand unit includes an alert that comprises a vibratory motor.

3. The communications device of claim 1 wherein said first hand unit and said second hand unit are reversibly associated with a steering wheel of a vehicle.

4. The communication device of claim 1 wherein the communications device is devoid of a screen that is connected to the steering wheel.

5. The communications device of claim 1 wherein said screen, first keyboard and second keyboard are in wireless communication to a cell phone in said vehicle.

6. The device of claim 1, wherein said device further comprises a portable heads-up display device comprising a projector engine disposed in a housing; a curved screen coupled to the housing so that light from the projector engine is incident on having an inner surface of said curved screen, said housing adapted to be tilted upwardly from the direction of incident light projected from the projector engine.

7. The device of claim 6, further comprising a combiner coupled to the housing that is adapted to be tilted upwardly from the direction of reflected light from the screen, said combiner having a concave surface that has a dichroic coating to reflect light of selected wavelengths.

8. The device of claim 6, wherein the hand detecting sensor is coupled to the projector engine.

9. The device of claim 6, wherein the projector engine project images on the screen that are pre-distorted to compensate for distortion in the image appearing at the combiner.

10. The device of claim 6, further comprising a means for sensing ambient light conditions at the heads-up display device, said means for sensing adapted to adjust the brightness of projected light responsive to ambient light conditions.

11. A communications device for use with a vehicle to facilitate safe texting while driving, comprising a housing; a projector engine disposed in the housing; a screen coupled to the housing so that light from the projector engine is incident on a surface of the screen; a semi-transparent combiner coupled to the housing to receive light reflected from the screen; a first hand unit attached to said steering wheel adjacent the left hand of the user, said first hand unit comprising a first alpha-numeric keyboard suitable for texting with the left thumb;
a second hand unit attached to said steering wheel adjacent the right hand of said user, said second hand unit comprising a second alpha-numeric keyboard suitable for texting with the right thumb wherein said first alpha-numeric keyboard includes some but not all of the letters of the alphabet and said second alpha-numeric keyboard includes at least those letters of the alphabet not on said first alpha-numeric keyboard, wherein said first keyboard and said second keyboard form a complete qwerty keyboard suitable for texting;
a hand detecting sensor associated with the first hand unit and the second hand unit, said hand detecting sensor adapted to preclude text communications from being entered on either of said first hand unit or said second hand unit if a driver's hands are not both contacting a steering wheel to which said communications device is attached;
wherein when a driver's left and right hands are in contact with the steering wheel in approximately 10 o'clock and 2 o'clock positions about the steering wheel, the driver is able to input text by using his/her respective thumbs, with the image of such texts being projected onto the screen such that text can be read by the driver while said driver's view is maintained through the front windshield of the vehicle, and a means for sensing ambient light conditions that is adapted to adjust the brightness of projected light responsive to ambient light conditions.

12. The device of claim 11, further comprising a forward-facing camera for capturing images of a road upon which the vehicle is traveling.

13. A communications device for use with a vehicle to facilitate safe texting while driving, comprising a housing; a projector engine disposed in the housing; a screen coupled to the housing so that light from the projector engine is incident on a surface of the screen; a semi-transparent combiner coupled to the housing to receive light reflected from the screen; a first hand unit attached to said steering wheel adjacent the left hand of the user, said first hand unit comprising a first alpha-numeric keyboard suitable for texting with the left thumb;
a second hand unit attached to said steering wheel adjacent the right hand of said user, said second hand unit comprising a second alpha-numeric keyboard suitable for texting with the right thumb wherein said first alpha-numeric keyboard includes some but not all of the letters of the alphabet and said second alpha-numeric keyboard includes at least those letters of the alphabet not on said first alpha-numeric keyboard, wherein said first keyboard and said second keyboard form a complete qwerty keyboard suitable for texting;
a hand detecting sensor associated with the first hand unit and the second hand unit, said hand detecting sensor adapted to preclude text communications from being entered on either of said first hand unit or said second hand unit if a driver's hands are not both contacting a steering wheel to which said communications device is attached;
wherein when a driver's left and right hands are in contact with the steering wheel in approximately 10 o'clock and 2 o'clock positions about the steering wheel, the driver is able to input text by using his/her respective thumbs, with the image of such texts being projected onto the screen such that text can be read by the driver while said driver's view is maintained through the front windshield of the vehicle; said first keyboard and second keyboard adapted to be in wireless communication with a smart phone of the driver of said vehicle.

14. The device of claim 13, wherein said device further comprises a portable heads-up display device comprising a projector engine disposed in a housing; a curved screen coupled to the housing so that light from the projector engine is incident on having an inner surface of said curved screen, said housing adapted to be tilted upwardly from the direction of incident light projected from the projector engine.

15. The device of claim 13, further comprising a combiner coupled to the housing that is adapted to be tilted upwardly from the direction of reflected light from the screen, said combiner having a concave surface that has a dichroic coating to reflect light of selected wavelengths.

16. The device of claim 6, wherein the hand detecting sensor is coupled to the projector engine.

17. The device of claim 13, wherein the projector engine project images on the screen that are pre-distorted to compensate for distortion in the image appearing at the combiner.

18. The device of claim 13, further comprising a means for sensing ambient light conditions at the heads-up display device, said means for sensing adapted to adjust the brightness of projected light responsive to ambient light conditions.

19. The communications device of claim 13, wherein said first hand unit and said second hand unit are reversibly associated with a steering wheel of a vehicle.

20. The communication device of claim 13, wherein the communications device is devoid of a screen that is connected to the steering wheel.
